(19) United States
(12) Patent Application Publication
(10) Pub. No.: US 2007/0024890 A1
(43) Pub. Date: Feb. 1, 2007

(54) Image forming apparatus, image forming apparatus control program, and image forming apparatus control method

(75) Inventor: Kazumi Murata, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/191,694

(22) Filed: Jul. 27, 2005

(51) Int. Cl. G06K 15/00

(52) U.S. Cl. 358/1.14; 358/448

(57) ABSTRACT

There is disclosed an image forming apparatus, image forming apparatus control program, and image forming apparatus control method which facilitate permission to access a document file. The image forming apparatus comprises: a document file registration section which creates a document file according to an instruction from a first user and registers the document file together with a contact address of the first user; an information obtaining section which receives an access request for access to the document file, according to an instruction from a second user, obtains a contact address of the second user, based on the access request, and obtains the contact address of the first user from the document file; a permission request sending section which sends, to the contact address of the first or second user, a permission request for permission to access the document file; and a document file sending section which sends the document file to the second user if the permission is received.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### RELATED APPLICATION INFORMATION

This patent is related to ______, which is incorporated herein by reference.

### BACKGROUND OF THE INVENTION

1. Field of the Invention

The present invention relates to an image forming apparatus, image forming apparatus control program, and an image forming apparatus control method, by which a stored document file can be accessed via a network.

2. Description of the Related Art

In a conventional image forming apparatus such as MFP (Multi Function Peripheral), temporary folders and folders specified by users are used as locations to store document files such as an image. Some of these folders are freely accessible. Some others are given rights set to allow only limited users to access and read. For some other folders, permission codes are set in advance so that the folders might not be accessed unless permission codes are inputted.

Known conventional art related to the present invention is, for example, the patent document 1 cited below. According to an information management method in this document, an information data creation user ID, an information management code for setting an access right to an arbitrary user, and the like as well as information data are stored. When arbitrary information data is accessed from an arbitrary user, a control device determines whether an access right given to the user is valid or not. If valid, information data is presented.

[Patent Document 1] Japanese Patent Application Laid-Open Publication No. 2004-178119

However, if a temporary folder as mentioned above is a shared folder which is freely accessible, there is a problem that all the documents stored therein can be accessed by everybody. Alternatively, if an access right is set for a folder and if no access right is given to a user who is going to access the folder, the user needs to request a creator or manager of a document file to change the access right. To save time and labor for such a procedure, it is necessary to know in advance who will access a document file when setting an access right at the time of creating a document file.

The present invention has been made to solve problems described above, and has an object of providing an image forming apparatus, image forming apparatus control program, and image forming apparatus control method, which facilitate the procedure of permitting access to a document file.

### DESCRIPTION OF THE DRAWINGS

FIG. 1 is a block diagram showing an example of the structure of a document file management system according to the present invention;

FIG. 2 is a sequence chart showing an example of operation when requesting access to a document file in a document file management system according to an embodiment 1;

FIG. 3 is a view showing an example of a list screen listing document files;

FIG. 4 is a view showing an example of a permission code input screen;

FIG. 5 is a sequence chart showing an example of operation when requesting access to a document file in a document file management system according to an embodiment 2;

FIG. 6 is a sequence chart showing an example of operation when requesting access to a document file in a document file management system according to an embodiment 3; and

FIG. 7 is a sequence chart showing an example of operation when requesting access to a document file in a document file management system according to an embodiment 4.

### DETAILED DESCRIPTION OF THE INVENTION

Embodiments of the present invention will now be described below with reference to the drawings.

Throughout this description, the embodiments and examples shown should be considered as exemplars, rather than limitations on the apparatus, methods and programs of the present invention.

### Embodiment 1

In the present embodiment, an MFP is used as an example of an image forming apparatus. A description will be made of a document file management system having this MFP.

The structure of the document file management system will be described first.

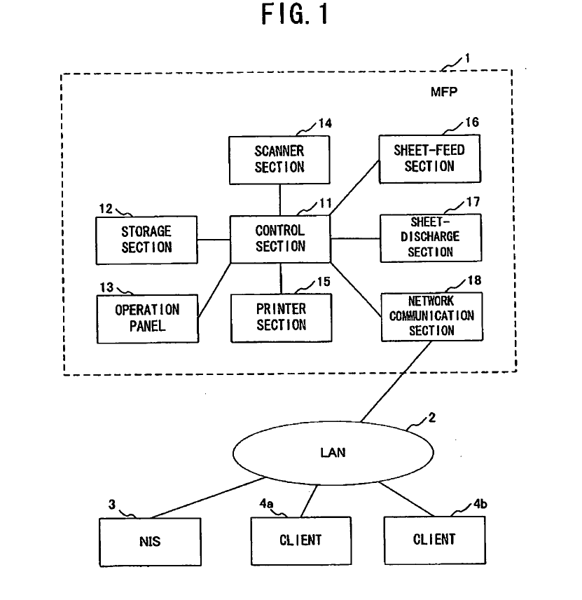

FIG. 1 is a block diagram showing an example of a document file management system according to the present invention. Via a LAN 2, an MFP 1, NIS (Network Information Server) 3, and clients 4a and 4b are connected. The MFP 1 includes a control section 11, storage section 12, operation panel 13, scanner section 14, printer section 15, sheet-feed section 16, sheet-discharge section 17, and network communication section 18.

The control section 11 serves to perform various processings in the MFP 1. The control section 11 also serves to execute programs stored in the storage section 12, to achieve various functions. The storage section 12 is constituted by, for example, a ROM, RAM, or the like, and serves to store various information and programs used in the MFP 1, as well as document files such as images obtained by the scanner section 14. The operation panel 13 displays information from the control section 11 and also receives a user's operation with respect to the control section 11. The scanner section 14 obtains images. The printer section 15 prints out document files or the like read from the storage section 12. The sheet-feed section 16 feeds paper sheets for printing. The sheet-discharge section 17 discharges paper sheets after printing. The network communication section 18 communicates external devices via the LAN 2.

Operation of the document file management system will be described next.

Described below is a case that a user B uses a client 4b to request access to a document file. The target of the access request will be referred to as a target document file. Suppose that the user A who is the creator of the target document file uses the client 4a.

Setting of the MFP 1 will be described first. In advance, a user ID, electronic mail address, and the like are set in a template for every user. In some conventional cases, electronic mail addresses are set as sending destinations of those document files that are created by scanning, and information of these electronic mail addresses may be used.

A next description will be made of operation to create a document file in the MFP 1. The MFP 1 performs scanning in accordance with instructions from the user A who has created the file. When document data thus obtained, such as an image, is stored as a document file, the MFP 1 requests the user ID of the user A. After a user ID is inputted by the user A, the MFP 1 stores a preset template corresponding to the user ID, as document information together with the document file. In other words, document information including a user ID, an electronic mail address, and the like in addition to document data is stored in the document file. Furthermore, a permission code used for permitting access to the document file is set in the document information. The present embodiment will now be described with respect to a case that another user B who is going to access a target document file does not know the permission code of the target document file.

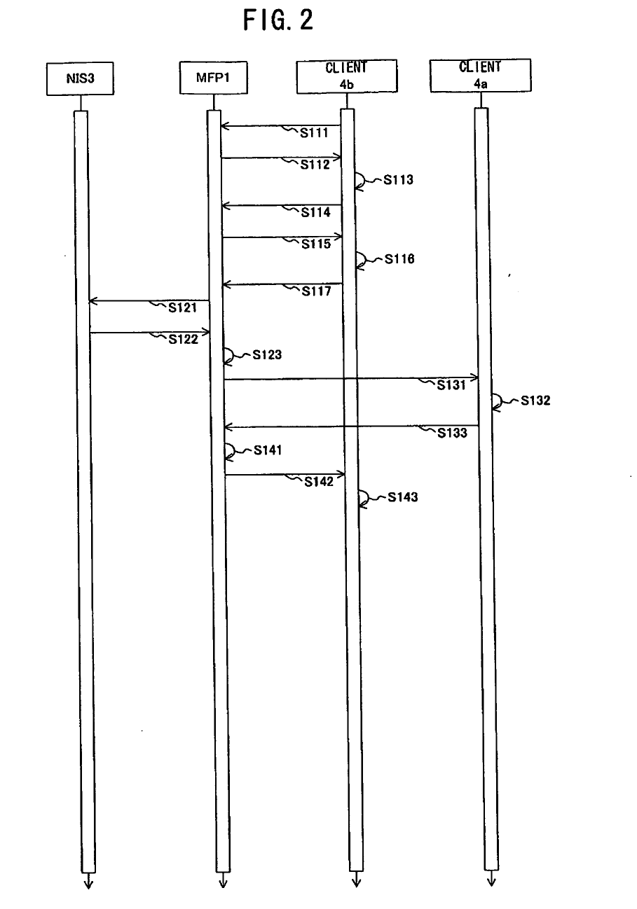

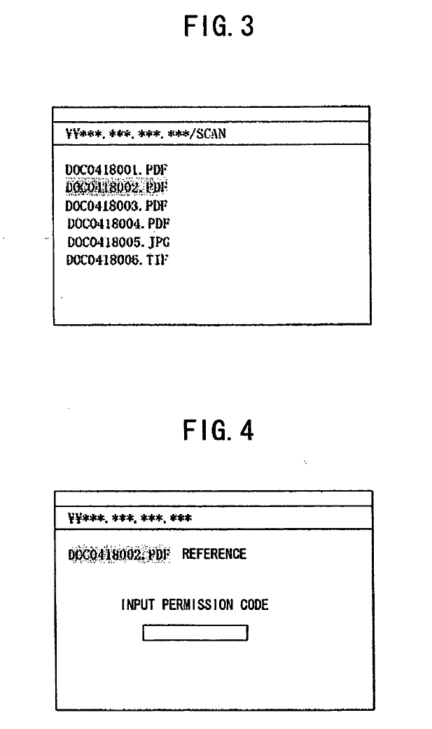

A next description will be made of operation in the case that the user B accesses a document file by use of a client 4b. FIG. 2 is a sequence chart showing an example of operation when requesting access to a document file in the document file management system according to the embodiment 1. At first, a Web browser of the client 4b requests a list of document files in a shared folder in the MFP 1 in accordance with an instruction from the user B (S111). Upon reception of the request, the MFP 1 sends a list of document files to the client 4b (S112). The Web browser of the client 4b which has received the list of document files shows a screen listing the document files (S113). FIG. 3 is a view showing an example of the screen listing document files. Next, a target document file is selected by an instruction from the user B. Then, the Web browser of the client 4b requests the MFP 1 to access the target document file (S114).

The MFP 1 which has received the access request sends a permission code input screen to the client 4b (S115). The Web browser of the client 4b which has received the permission code input screen shows the permission code input screen (S116). FIG. 4 is a view showing an example of the permission code input screen. If the user B does not input a permission code through the permission code input screen but cancellation of inputting of a permission code is sent to the MFP 1 (S117), thereafter, the MFP 1 performs a processing to obtain, from the user A, permission for access.

Next, the MFP 1 requests, from the NIS 3, user information which is information concerning the user B who required accesses (S121). The MFP 1 then receives the user information (S122). Next, the MFP 1 obtains document information from a target document file (S123). The user information includes identification information, an electronic mail address, and the like of the user B. The document information includes identification information of the target document file, and an electronic mail address of the user A.

Next, the MFP 1 creates an electronic mail, describing that a reply is asked about whether access to the target document file should be permitted or not with respect to the identification information of the user B, the identification information of the target document file, and the user B. The MFP 1 addresses the mail to the electronic mail address of the user A, and sends the mail to the client 4a (S131).

A mailer of the client 4a which has received the electronic mail from the MFP 1 creates an electronic mail indicative of permission or refusal of the access in accordance with an instruction from the user A, as a reply to the received electronic mail (S132), and sends the reply to the MFP 1 (S133).

The MFP 1 which has received the replying electronic mail from the client 4a determines whether the contents of the received electronic mail express permission or not (S141). Unless the contents of the electronic mail express permission, the MFP 1 sends a message indicative of refusal of access, to the client 4b. The Web browser of the client 4b displays a message (not shown) indicative of refusal of access. This sequence then ends. Otherwise, if the contents of the electronic mail express permission, a target document file is sent to the client 4b (S142). The Web browser of the client 4b displays the document files received (S143). The sequence then ends.

### Embodiment 2

The structure of the document file management system according to the present embodiment is the same as that of the embodiment 1. Settings in the MFP 1 and operation of the MFP 1 to create a document file are also the same as those of the embodiment 1.

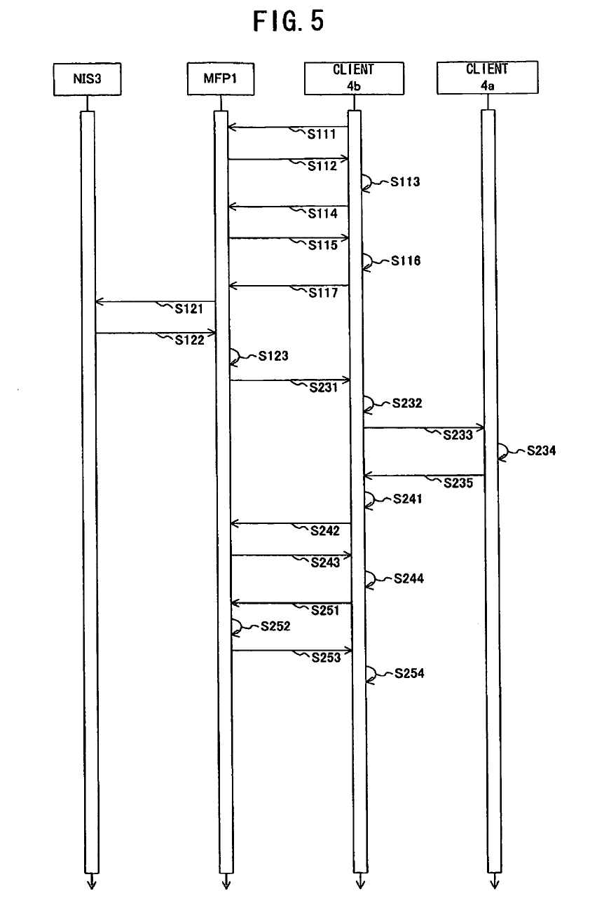

Next, a description will be made of a case that a user B accesses a document file by use of a client 4b. FIG. 5 is a sequence chart showing an example of operation when requesting access to a document file in the document file management system according to the embodiment 2. At first, the operation from the processing step S111 to the processing step S123 is carried out, like in the embodiment 1.

The MFP 1 sends, to the client 4b, a message describing that the creator of a target document file is a user A and a permission code needs to be obtained from the user A and also describing an electronic mail address of the user A (s231).

Next, the Web browser of the client 4b displays the received message (S232). Next, in accordance with an instruction from the user B, a mailer of the client 4b creates an electronic mail which requests a permission code from the user A. The mailer sends the mail to the client 4a, by addressing the mail to the mail address of the user A (S233).

The mailer of the client 4a which has received the electronic mail from the user B creates an electronic mail indicative of permission or refusal of access in accordance with an instruction from the user A, as a reply to the received electronic mail (S234), and sends the reply to the client 4b (S235). If the user A permits access, the user A inputs a permission code preset in the target document file, to the electronic mail.

If access is denied by an instruction from the user A, the mailer of the client 4b which has received the electronic mail from the user A displays the electronic mail indicative of access denied (not shown), and then this flow ends.

Otherwise, if access is permitted by an instruction from the user A, the mailer of the client 4b which has received the electronic mail from the user A displays this electronic mail, to inform the user B of a permission code (S241).

Next, in accordance with an instruction from the user B, the Web browser of the client 4b requests again, from the MFP 1, access to the target document file (S242). The MFP 1 which has received the access request sends a permission code request to the client 4b (S243). The Web browser of the client 4b which has received the permission code request displays a permission code request screen (S244), accepts input of a permission code from the user B, and sends a permission code to the MFP 1 (S251). The MFP 1 which has received the permission code compares the received permission code with a permission code included in document information (S252). If both codes are equal to each other, the MFP 1 sends the target document file to the client 4b (S253). The Web browser of the client 4b which has received the target document file displays the file (S254), and then this flow ends.

### Embodiment 3

The structure of the document file management system according to the present embodiment is the same as that of the embodiment 1. Settings in the MFP 1 and operation of the MFP 1 to create a document file are also the same as those of the embodiment 1.

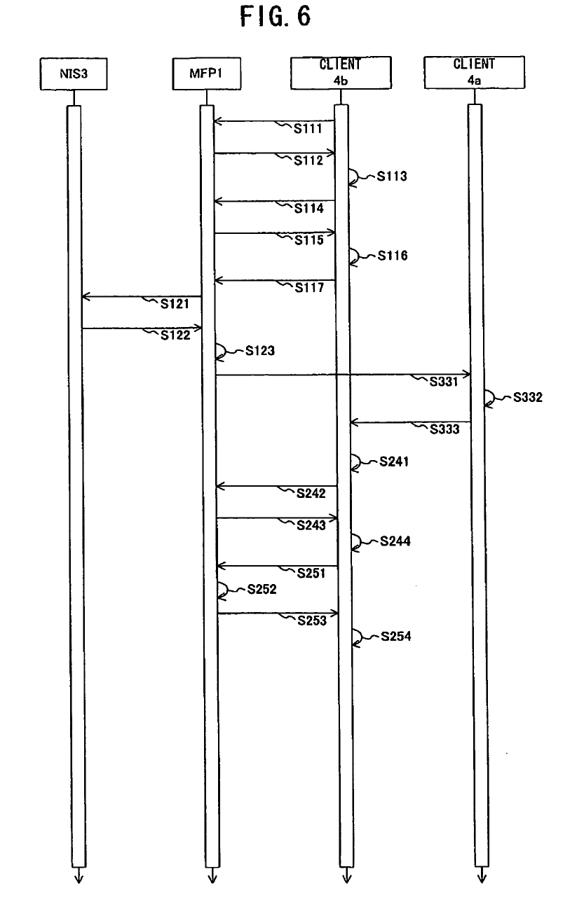

A next description will be made of operation in a case that the user B accesses a document file by use of the client 4b. FIG. 6 is a sequence chart showing an example of operation when requesting access to a document file in the document file management system according to the embodiment 3. At first, the operation from the processing step S111 to the processing step S123 is carried out, like in the embodiment 1.

Next, the MFP 1 creates an electronic mail describing that the user B requests access to a target document file and would like to be informed of a permission code of the target document file if access is permitted, and describing an electronic mail address of the user B as a sending destination of the permission code. The MFP 1 sends the mail to the client 4a by addressing the mail to an electronic mail address of the user A (S331).

A mailer of the client 4a which has received the electronic mail from the MFP 1 creates an electronic mail indicative of permission or refusal of access in accordance with an instruction from the user A (S332), and sends this mail to the client 4b (S333). If the user A permits access, a permission code preset in the target document file is written in this electronic mail.

If access is denied by an instruction from the user A, the mailer of the client 4b which has received the electronic mail from the user A displays the electronic mail indicative of access denied (not shown), and then this flow ends.

Otherwise, if access is permitted by an instruction from the user A, the operation from the processing step S241 to S254 is carried out, like in the embodiment 2.

### Embodiment 4

The structure of the document file management system according to the present embodiment is the same as that of the embodiment 1. Settings in the MFP 1 and operation of the MFP 1 to create a document file are also the same as those of the embodiment 1.

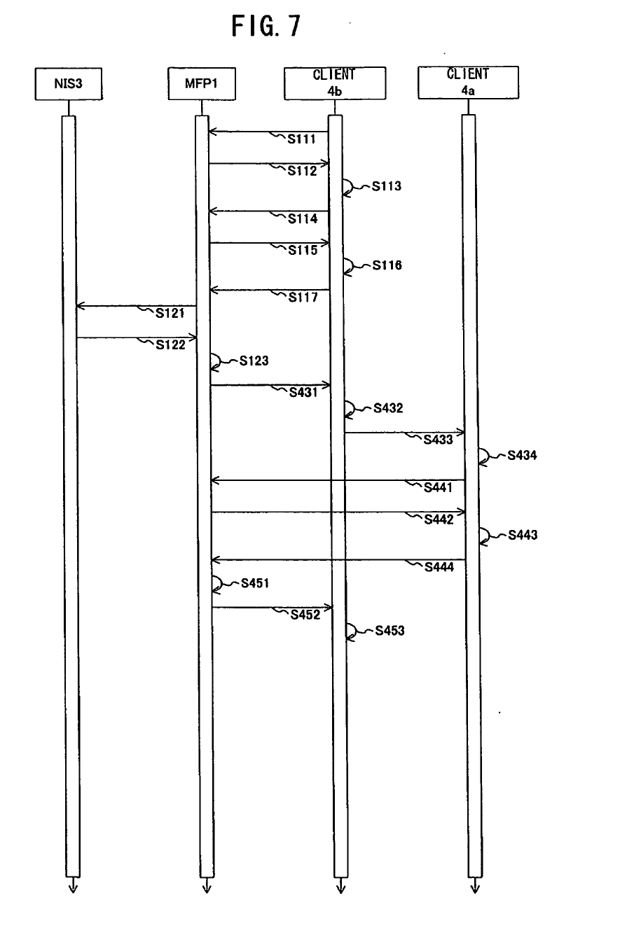

A next description will be made of operation in a case that the user B accesses a document file by use of a client 4b. FIG. 7 is a sequence chart showing an example of operation when requesting access to a document file management system according to the embodiment 4. At first, the operation from the processing step S111 to the processing step S123 is carried out, like in the embodiment 1.

Next, the MFP 1 sends, to the client 4b, a message describing that the creator of a target document file is the user A and it is necessary to request the user A to input a permission code, and describing an electronic mail address of the user A (S431).

Next, the Web browser of the client 4b displays the message received (S432). Next, the mailer of the client 4b creates an electronic mail describing a URL (Uniform Resource Locator) where the user A can input a permission code. The mailer sends the mail to the client 4a by addressing the mail to the electronic mail address of the user A (S433).

The mailer of the client 4a which has received the electronic mail from the user B displays the electronic mail received (S434). If access is denied by an instruction from the user A who has checked the received electronic mail (not shown), this flow ends.

Otherwise, if access is permitted by an instruction from the user A who has checked the received electronic mail, the Web browser of the client 4a accesses the URL to input a permission code, in accordance with a further instruction from the user A (S441). In response to the access to the URL, the MFP 1 sends a permission code input screen to the client 4a (S442). The Web browser of the client 4a which has received the permission code input screen displays the permission code input screen (S443), and sends a permission code to the MFP 1, in accordance with an instruction from the user A (S444).

The MFP 1 which has received the permission code compares the received permission code with a permission code included in document information (S451). If both codes are equal, the MFP 1 sends a target document file to the client 4b (S452). The Web browser of the client 4b which has received the target document file displays the target document file (S453), and this flow then ends.

In the above-described embodiments, the Web browser of the client 4b and the mailers of the clients 4a and 4b are used. Alternatively, a program having an equivalent communication function and an equivalent input/output function may be used in the clients 4a and 4b. Although electronic mails are used as communication means between the clients 4b and 4a, any other communication means such as a messenger may be used.

Also in the embodiments, user information of the user B who requested access is obtained from the NIS 3. Alternatively, user information may be set in advance in the MFP 1 or another server.

A document file registration section, information obtaining section, permission request sending section, and document file sending section correspond to the control section in each of the embodiments. A document file registration step corresponds to operation performed when creating a document file in the embodiments. An information obtaining step corresponds to the processing steps S121, S122, and S123 in the embodiments. A permission request sending step corresponds to the processing steps S131, S231, S331, and S431 in the embodiments. A document file sending step corresponds to the processing steps S142, S253, and S452 in the embodiments.

Each of the steps in the processings carried out by the MFP 1 is achieved by making the control section 11 execute an image forming apparatus control program stored in the storage section 12.

The above embodiments have been described with reference to a case that the apparatus internally records a function to practice the present invention. However, the present invention is not limited to this case but the same function may be downloaded to the apparatus from a network. Alternatively, the same function may be installed into the apparatus from a recording medium which stores the function. The recording medium may be of any type as far as the recording medium is capable of storing a program, like a CD-ROM, and is readable by the apparatus. Further, the function which can thus obtained by installation or downloading in advance may be achieved in cooperation with the OS (Operating System) in the apparatus.

Although shown implemented in a multi function peripheral (MFP), the invention may be implemented with any computing device. A computing device as used herein refers to any device with a processor, memory and a storage device that may execute instructions including, but not limited to, multi function peripherals (MFPs), printers, and scanners. These computing devices may run any operating system, including, for example, variations of the Linux, Unix, MS-DOS, Microsoft Windows, Palm OS, and Apple Mac OS X operating systems.

Although the techniques discussed herein are described with regard to a compact disk, the techniques may be implemented with any storage media in any storage device included with or otherwise coupled or attached to a computing device. These storage media include, for example, magnetic media such as hard disks, floppy disks and tape; optical media such as compact disks (CD-ROM and CD-RW) and digital versatile disks (DVD and DVD±RW); flash memory cards; and any other storage media. As used herein, a storage device is a device that allows for reading and/or writing to a storage medium. Storage devices include, hard disk drives, DVD drives, flash memory devices, and others.

By data unit, it is meant a frame, cell, datagram, packet or other unit of information.

According to the present invention, the creator of a document file need not set an access right in advance, knowing exactly who will access the document file. Further, since a MFP mediates between users and the creator of a document file, a procedure of permitting access can be carried out easily. Access control in units of document files can be achieved also easily.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

It is claimed:

1. An image forming apparatus capable of externally accessing a document file via a network, comprising:
a document file registration section that creates a document file according to an instruction from a first user and registers the document file together with a contact address of the first user;
an information obtaining section that receives an access request for access to the document file, according to an instruction from a second user, obtains a contact address of the second user, based on the access request, and obtains the contact address of the first user from the document file;
a permission request sending section that sends, to the contact address of the first or second user, a permission request for permission to access the document file; and
a document file sending section that sends the document file to the second user when the permission is received.

2. The image forming apparatus according to claim 1, wherein
the permission request sending section sends information of the document file and the permission request including the contact address of the second user, to the contact address of the first user, and
the permission is prepared based on the permission request, and is sent to the image forming apparatus upon an instruction from the first user.

3. The image forming apparatus according to claim 1, wherein
the permission request sending section sends, to the contact address of the second user, the permission request including the contact address of the first user, and
the permission is information which the second user has obtained from the first user on the basis of the permission request, and is sent to the image forming apparatus in accordance with an instruction from the second user.

4. The image forming apparatus according to claim 1, wherein
the permission request sending section sends, to the contact address of the first user, information of the document file and the permission request including the contact address of the second user, and
the permission is information which the first user has sent to the second user, based on the permission request, and is sent to the image forming apparatus from the second user.

5. The image forming apparatus according to claim 1, wherein
the permission request sending section sends the permission request including the contact address of the first user to the contact address of the second user, and
the permission is information which the second user has obtained from the first user, based on the permission request, and is sent to the image forming apparatus in accordance with an instruction from the second user.

6. The image forming apparatus according to claim 1, wherein the contact addresses are electronic mail addresses.

7. The image forming apparatus according to claim 1, wherein the information obtaining section conducts an inquiry to the NIS, based on the sending source of the access request, and obtains the contact address of the second user.

8. An image forming apparatus control program to make a computer execute control of an image forming apparatus capable of externally accessing a document file via a network, the program comprising:
a document file registration step that creates a document file according to an instruction from a first user and registers the document file together with a contact address of the first user;
an information obtaining step that receives an access request for access to the document file, in accordance with an instruction from a second user, obtains a contact address of the second user, based on the access request, and obtains the contact address of the first user from the document file;
a permission request sending step that sends, to the contact address of the first or second user, a permission request for permission to access the document file; and
a document file sending step that sends the document file to the second user when the permission is received.

9. The image forming apparatus control program according to claim 8, wherein
in the permission request sending step, information of the document file and the permission request including the contact address of the second user are sent to the contact address of the first user, and
the permission is prepared based on the permission request, and is sent to the image forming apparatus upon an instruction from the first user.

10. The image forming apparatus control program according to claim 8, wherein
in the permission request sending step, the permission request including the contact address of the first user is sent to the contact address of the second user, and
the permission is information which the second user has obtained from the first user on the basis of the permission request, and is sent to the image forming apparatus in accordance with an instruction from the second user.

11. The image forming apparatus control program according to claim 8, wherein
in the permission request sending step, information of the document file and the permission request including the contact address of the second user are sent to the contact address of the first user, and
the permission is information which the first user has sent to the second user, based on the permission request, and is sent to the image forming apparatus from the second user.

12. The image forming apparatus control program according to claim 8, wherein
in the permission request sending step, the permission request including the contact address of the first user is sent to the contact address of the second user, and
the permission is information which the second user has obtained from the first user, based on the permission request, and is sent to the image forming apparatus in accordance with an instruction from the second user.

13. The image forming apparatus control program according to claim 8, wherein the contact addresses are electronic mail addresses.

14. The image forming apparatus control program according to claim 8, wherein in the information obtaining step, an inquiry is conducted to the NIS, based on the sending source of the access request, and the contact address of the second user is obtained.

15. An image forming apparatus control method of controlling an image forming apparatus capable of externally accessing a document file via a network, the method comprising:
a document file registration step that creates a document file according to an instruction from a first user and registers the document file together with a contact address of the first user;
an information obtaining step that receives an access request for access to the document file, in accordance with an instruction from a second user, obtains a contact address of the second user, based on the access request, and obtains the contact address of the first user from the document file;
a permission request sending step that sends, to the contact address of the first or second user, a permission request for permission to access the document file; and
a document file sending step that sends the document file to the second user when the permission is received.

16. The image forming apparatus control method according to claim 15, wherein
in the permission request sending step, information of the document file and the permission request including the contact address of the second user are sent to the contact address of the first user, and
the permission is prepared based on the permission request, and is sent to the image forming apparatus upon an instruction from the first user.

17. The image forming apparatus control method according to claim 15, wherein
in the permission request sending step, the permission request including the contact address of the first user is sent to the contact address of the second user, and
the permission is information which the second user has obtained from the first user on the basis of the permission request, and is sent to the image forming apparatus in accordance with an instruction from the second user.

18. The image forming apparatus control method according to claim 15, wherein
in the permission request sending step, information of the document file and the permission request including the contact address of the second user are sent to the contact address of the first user, and
the permission is information which the first user has sent to the second user, based on the permission request, and is sent to the image forming apparatus from the second user.

19. The image forming apparatus control method according to claim 15, wherein
in the permission request sending step, the permission request including the contact address of the first user is sent to the contact address of the second user, and
the permission is information which the second user has obtained from the first user, based on the permission request, and is sent to the image forming apparatus in accordance with an instruction from the second user.

20. The image forming apparatus control method according to claim 15, wherein the contact addresses are electronic mail addresses.
